(19) United States
(12) Patent Application Publication
(10) Pub. No.: US 2019/0140673 A1
(43) Pub. Date: May 9, 2019

(54) DEVICE FOR LOCATING AND IDENTIFYING PERSON, ANIMAL OR ARTICLE

(71) Applicant: Jorge Aldo Calosso Acosta, Montevideo (UY)

(72) Inventor: Jorge Aldo Calosso Acosta, Montevideo (UY)

(21) Appl. No.: 16/229,541

(22) Filed: Dec. 21, 2018

(30) Foreign Application Priority Data
Dec. 22, 2017 (CN) 201721825780.9

(51) Int. Cl. H04B 1/034; G01S 19/01

(52) U.S. Cl. CPC H04B 1/0343; G01S 19/01

(57) ABSTRACT

Device to identify and/or locate people or objects comprising a belt and a region that has a GPS unit, at least one medium that has information, a means to transmit the information to a receiving apparatus and a battery.

### TECHNICAL FIELD

The present invention is applicable to the field of registration supporting, more specifically, to the applying field of supporting recording via a machine.

### BACKGROUND ART

The development of such device and system is promoted under the requirement for security regarding identification of a person, an animal or article. In regard to a person, a monitoring device can be used to ensure that a person entering into a certain place or conducting a transaction is authenticated. In regard to an article, it is mainly used for theft protection.

Meanwhile, the personnel location function plays a very important role in the field of locking up the position of a wanted criminal or kidnapper. In regard to an animal or an article, it is used for locking up the position of the article or animal before possible theft or harm.

Application No. CN20052106516U is a piece of identification card with the functions of GPS and storage circuit, the storage circuit is used for storing personal and external data. But the card cannot be used by a user for a long time. Similar applications involving such defect include CN105447560, CN101244661 and CN203455856(U).

Application No. WO2005006647 is a piece of identification card supporting GPS and an electronic file system. The inconvenience of this card is similar to the previous situation: namely incapable of supporting long-term use.

Application No. KR20100068527 is a piece of automobile chip having functions both of RFID and GPS, it is suitable for tracking the position of stolen vehicles, while not suitable for a person or an animal.

Therefore, it is necessary to invent a device capable of identifying and locating a person, an animal and an article at the same time.

### SUMMARY OF THE UTILITY MODEL

The present invention is a device for locating and identifying a person, an animal or an article, the device comprises:
a. a closable hoop;
b. fastening the hoop in an indestructible or permanent manner;
c. the portion connected with the above hoop comprises:
I—at least one information storage device;
   II—a GPS device;
   III—a device capable of transmitting position and information to an outer receiving device remotely. The device is connected with a medium for storing information and GPS, and provided with two electrical terminals.
   IV—a battery;
d—a primary conductor, for directly connecting one pole of the battery with a terminal, and for remotely transmitting information;
e—a secondary conductor, located in the hoop and extending to a middle position of the hoop from another pole of the battery, thus closing the hoop;
f—a third conductor, located in the hoop and extending to another terminal of the information transmission medium from the middle position of the hoop to close the hoop, so that the hoop closure device enables the secondary conductor to be connected with the third conductor when the hoop is closed annularly.

The sentence of “closing an opening portion in an indestructible or permanent manner” means that the device cannot be opened manually once the device is closed unless a proper tool is utilized, e.g., tweezers or pliers.

“Conductor” refers to any conductive medium. These are rather familiar conventional conductors for those skilled in the art who usually choose a proper one according to the need, preferably, bare wire or cable is chosen.

The primary, secondary and third conductors may be all the same, may be partially the same, or may be all different.

The section of the hoop may be of any shape as long as the conductor can be embedded therein. Such as, it can be a rectangular section, an elliptical section or a circular section.

The hoop can be made of any known suitable material. Preferably, it is made of leather or high molecular material, more preferably the polymer material.

The portion connected with the hoop includes an information storage medium and a GPS device. The storage medium and battery can be made of any material suitable for accommodating the above components, wherein it is preferably formed of a plastic material or a metal material. In view of the cost factor, the plastic material is preferred.

Such portion can be connected on the hoop in any way, e.g., suitable rivets or glue as long as such way can prevent the portion disengaging from the hoop.

If cable or bare wire is used as a conductor, be sure to choose the electric wire or cable with very small diameter of conductor, because the amperage of the current flowing through the wire is rather weak. These skilled in the art would know that the diameter of the wire should be less than the width of the hoop.

Preferably, the section of the bare wire or cable is less than 1 mm2, more preferably less than 0.50 mm2, and most preferably less than 0.25 mm2.

To achieve the intended fastening effect, any known closing means can be taken available, once the hoop is fastened, the device cannot be opened manually.

Such kind of fastening way is similar to a bovine ear tag device tracking livestock. The device has a cathode and an anode. The device cannot be separated manually once two poles are locked. In addition, external anode and internal cathode are made of conductive metal materials. Such device similar to the bovine ear tag can be seen at: http://www.datamars.com.uy/producto_descrip_ganaderia.php?idp=12.

Another locking way is to embed a hook with retractable fins. The fin is located in an opening end of the hoop and embedded into a hollow region with an entry ramp, and the diameter of the entry ramp is less than the hollow region. The hollow region with an entry ramp is located in another end of the hoop.

When an end portion of the fin is inserted into the entry ramp, the fin shrinks and makes its end portion passing through the entry ramp. The fin expands again after reaching to the hollow region, thus preventing the device from being opened manually. To make the fin shrinking freely, a spring or an elastic material matching the buckle accessory can be used.

The width of the portion for information storage, transmission medium and GPS accommodating may be the same with the hoop, the wider or narrower one is available.

Information can be stored in any proper medium, wherein the integrated circuit (chip) is the optimum storage mode.

To transmit the information and position of a user or an object, any known type of transmitter can be used, wherein a radio frequency transmitter is preferred. The medium for information transmission is respectively connected with GPS and a conventional device for data storage.

The medium for information transmission is provided with two terminals, used for connecting the conductor delivering power from the battery.

The battery can be selected an energy storage device in any chemical form. The rechargeable battery self-contained by the device or battery can be used. The battery can be a disposable battery or rechargeable battery.

If the self-contained rechargeable battery is used, the battery portion should be provided with a recharging component similar to that of a cellphone. Apparently, a standard charger is required in this case.

The hoop is designed to be put on any part of our body, the wrist or ankle is optimum.

The hoop can be manufactured in different length to fit different sizes (e.g., wrist or ankle) of users. It is preferably put on the wrist.

If the hoop is mounted on an object, e.g., vehicle, etc., the device can be placed on any portion allowing the hoop to be closed in a circular way.

For example, when the hoop is used on animals, e.g., cattle, sheep, etc., the device can be placed on any portion allowing the hoop to be closed in a circular way. Preferably, it is buckled on an animal's neck as a collar, because the possibility of damaging the device may drops to minimum when the animal moves in such portion.

As mentioned above, the wrist is the preferred wearing position for the device. In this way, it is convenient just like wearing a watch, and the hoop is fastened to avoid manual opening. Thus, the user can avoid missing the device unless it is cut by a suitable tool.

The user's location and data detected by GPS device can be transmitted by the device. These data can be collected by a set of receiving device located outside the common place (e.g., a shopping mall). Through such way, the owner of the place may know users' basic information, such as, name, age, ID card, whether there exists a past record and whether the user is on probation, so as to decide whether the user is allowed to access. The receiver can be equipped with a facial recognition or fingerprint identification auxiliary system.

The user needs a cutting tool to cut off the hoop. But such way will cut off the conductor transmitting electric current, causing the failure of information transmission by the device. In such case, the owner can decide to not allow the user to access into the place.

The system can be tracked by GPS, therefore in case of a crime, e.g., theft or kidnapping, the system can be used for locating the site of the crime or the criminal together with the kidnapped one for hunting.

The system can be also used for automobile theft cases by means of GPS location. In case that car accident has occurred, the system can be used for recording the information of accident vehicles to prevent the escape of the car owner. For this purpose, the vehicle should be equipped with a set of receiving device for data collection any time anywhere as well as completing corresponding electronic recording.

If the driving vehicle is equipped with the device and it happens that the pedestrian wearing the device runs the risk of being crushed, because GPS has a detection function, the device connected with automobile engine brakes automatically, thus avoiding a car accident.

GPS can detect a slowdown area, e.g., surroundings of a school, and make the vehicle stopping automatically or slowing down.

And the same is true for the situation of reaching traffic lights. The vehicle can stop automatically via GPS detection function when it turns red light. If the device is asynchronous with vehicle-mounted software, there is no need for the prompt of traffic lights.

If all cars are equipped with such devices, driving automation can be achieved. In this way, the vehicle can automatically adjust driving speed and position, thus avoiding collision.

When the product is used for animals, tracking and recognition functions can be achieved by the device basically.

### BRIEF DESCRIPTION OF THE DRAWINGS

The structure of this invention is briefly described hereafter with reference to drawings.

FIG. 1 is a view of the device of the invention when the hoop is opened.

FIG. 2 is a detailed drawing of the device when closed in the invention.

FIG. 3 is another detailed drawing of the device when closed as in the FIG. 2.

FIG. 4 is a view of the device of the invention when the hoop is opened.

FIG. 5 is the positions for users to wear.

### DETAILED DESCRIPTION OF THE INVENTION

The following is the reference drawings for use, and the drawings show the optimum application method, while it is not intended to limit the scope of the invention.

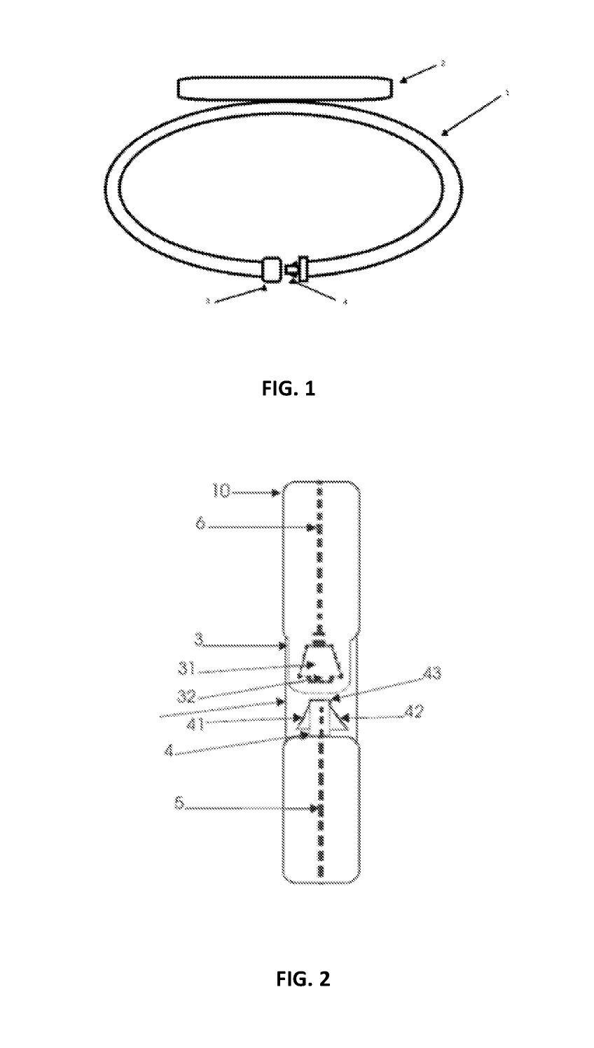

FIG. 1 is a view of the device of the invention when the hoop is opened. It can be seen that a hoop 1 is opened, a region 2, is embedded in plastic materials, and an integrated circuit composed of plastic is included therein, this part includes an integrated circuit containing user information, a GPS device, a radio frequency transmitter and a battery. Components in the region 2 are mutually connected, thus sending the integrated circuit and GPS data to a receiving device. The region 2, which may be identified as a tracking module, is attached on the hoop via glue.

One end of the hoop 1 is provided with a hook 4 containing retractable metal fins, a hook 3 is provided in an inner groove and an entry ramp of another end. Such configuration makes that the device cannot be opened manually once the hoop is closed unless a cutting tool is utilized.

FIG. 2 is a hook region of the hoop. A dark region 10 in the drawings is a forward-reaching portion of the hoop and a bright region 11 is a back-extending portion of the hoop. The dashed is corresponding to the conductor and the conductor in the drawings is composed of bare wire. A dashed 5 denotes a second bare wire, used for connecting the medium 4 of a closed hoop to the terminals of the battery, a dashed 6 denotes a third bare wire, used for connecting the medium 3 of another closed hoop to the terminals of the radio frequency transmitter. Such an inverse wiring way is known by skilled users: namely, the medium of a closed-opening hoop can be connected on the terminals of the radio frequency transmitter via bare wire 5, and other medium of the closed-opening hoop can be connected on the terminals of the battery via bare wire 6. Skilled users further know that the bare wire can be replaced by other conductors (e.g., cable).

FIG. 2 shows end portions 3 and 4 of the hook. A groove 31 of a metal wall and an entry ramp 32 can be seen at the end portion 3, wherein the ramp is narrower than the groove. Retractable metal fins 41 and 42 can be seen at the end portion 4.

The wire 5 is connected with terminals of the battery via retractable metal fins 41 and 42, and the metal wall of the groove 31 is connected with terminals of the radio frequency transmitter via the bare wire 6.

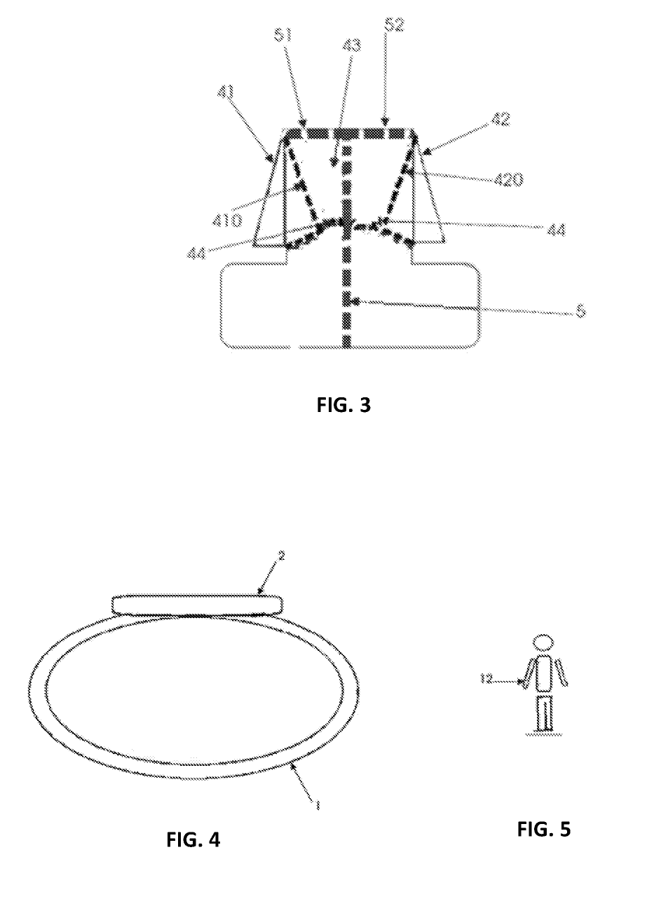

FIG. 3 is a detailed drawing of the end portion 4. The drawing shows that fins 41 and 42 can retract to axis 43. Inner part of the dashed 410 and 420 is the moving region of fins 41 and 42 within the axis. In such case, a spring 44 is compressed when fins shrink, and when fins extend, the spring 44 spread.

The second wire 5 is divided into two bare wires 51 and 52 which are respectively connected with retractable metal fins 41 and 42.

To close the hoop 1, make the axis 43 of the end portion 4 passing through a ramp 32. Meanwhile, fins 41 and 42 retract to the axis 43 and compress the spring 44. In case that the end portion 4 is inserted into a groove 31 to touch fins 41 and 42, the spring 44 stretches and opens two fins, thus keeping contact with the wall of the groove 31. In case that fins stretch in the groove, the hoop cannot be reopened unless it is cut by a suitable tool.

In addition, the fin and groove wall are made of metal materials, so it ensures conductive effects from battery terminals to the radio frequency transmitter, thus guaranteeing the normal use of the emitter. If the hoop is cut off, the wire is cut; the data or user position detected by the outdoor receiver is not transmitted by the emitter any longer. At this time, the owner will receive an alarm of unidentified identity and decide whether the user is allowed to access.

FIG. 4 is an effect graph when the hoop 1 is closed and an exterior view of the region 2.

FIG. 5 shows wearing positions of the device 12 on a user's wrist. Skilled users know that the device can be put on any proper portion of our body, such as, forearm, ankle and neck. It only needs to change the length of the hoop 1.

Through the device, the owner of a certain place knows the identity of a person who is about to access to the place and allows its access automatically or manually. Meanwhile, a fingerprint or facial recognition system is used to ensure whether the one wearing the hoop is the user.

If the user cuts off and removes the hoop, his/her personal data is not transmitted any more, the owner may decide whether the user is allowed to access into the place at this time.

1. A device for locating and identifying a person or an article, the device comprising:
a closable hoop, configured to be fastened in a permanent manner;
a tracking module, configured to be attached to said closable hoop, comprising:
at least one information storage device;
a GPS device;
a device capable of transmitting position and information to an outer receiving device remotely, comprising two electrical terminals;
a battery;
a primary conductor residing in said hoop, wherein said primary conductor allows for directly connecting one pole of said battery with a terminal, and remotely transmitting information;
a secondary conductor residing in said hoop, wherein said secondary conductor allows for directly connecting another pole of said battery with a terminal, thus closing said hoop; and
a third conductor residing in the hoop, wherein said third conductor allows for directly connecting one terminal of the information transmission medium from the middle position of said hoop to close said hoop.

2. The device according to claim 1, wherein one end of said hoop is firmly embedded in a permanent manner in a groove at another end of said hoop by a hook containing retractable fins.

3. The device according to claim 2, wherein said hoop is made of polymer materials.

4. The device according to claim 3, wherein said primary, secondary and third conductors are bare wire.

5. The device according to claim 3, wherein said battery is a rechargeable battery.

6. The device according to claim 4, wherein said device for information transmission is a radio frequency transmitter.
